(19) United States
(12) Patent Application Publication
(10) Pub. No.: US 2006/0272460 A1
(43) Pub. Date: Dec. 7, 2006

(54) Shaving razors

(76) Inventors: Cheng-Jih Li, Hopkinton, MA (US); Alfred Porcaro, Everett, MA (US); Robert A. Trotta, Pembroke, MA (US)

Correspondence Address: FISH & RICHARDSON P.C., P.O. BOX 1022, MINNEAPOLIS, MN, 55440-1022, US

(21) Appl. No.: 11/145,341

(22) Filed: Jun. 2, 2005

(51) Int. Cl. B26B 21/00

(52) U.S. Cl. 83/13; 30/32

(57) ABSTRACT

Razor blades and razors are provided. The razor blades include apertures, the perimeter of each aperture forming a cutting edge. The razor blades and razors are constructed so as to minimize gaps between the effective shaving zones of the apertures.

### TECHNICAL FIELD

This invention relates to razors, and more particularly to razors for wet shaving.

### BACKGROUND

In some razors, the shaving edge, rather than being defined by the linear edge of an elongated blade, is defined by an aperture in a broad surface of a blade. For example, as described in U.S. Pat. No. 5,088,195, the disclosure of which is incorporated herein by reference, a cutting edge is defined an aperture that has a sharpened edge. Generally, such razor blades will include an array of these apertures, e.g., apertures 12 shown in FIG. 1. Patents describing such shaving systems include, for example, U.S. Pat. Nos. 4,984,365, 5,088,195, 5,153,992 and 5,604,983, the disclosures of which are incorporated herein by reference.

### SUMMARY

The inventor has found that, when such razors are used, hairs can sometimes be missed due to small gaps between the effective shaving zones of the apertures. By “effective shaving zone,” we mean the portion of the sharpened edge of each aperture that is positioned to cut hair when the blade is disposed in a razor and used in a normal manner (i.e., the razor is moved across the skin in the direction intended by the manufacturer). These gaps are illustrated diagrammatically in FIGS. 2 and 2A. As shown in FIG. 2, when the blade is moved across the skin in the direction indicated by arrow A, each aperture 12 of the blade 10 has an effective shaving zone 14 that will cut hair when the blade is drawn over the skin. The cutting effectiveness within each zone 14 is distributed over a bell curve, as indicated by curves 16 in FIG. 2. These curves do not quite overlap, resulting in gaps 18, shown in detail in FIG. 2A. Each gap 18 is approximately 150-250 microns in width. The width of a human beard hair is generally approximately 80 to 150 microns, and thus these tiny gaps can result in missed hairs. The effective shaving zone may be estimated, for example, by image analysis of high speed photography.

In general, the invention features razors in which these gaps are minimized or eliminated, generally resulting in a close, clean shave with very few or no missed hairs.

In one aspect, the invention features a razor blade for use in a shaving system, the blade including a metallic foil sheet having a substantially planar surface with a plurality of apertures formed therein. The perimeter of each aperture forms a cutting edge, each cutting edge defining an effective cutting zone that will be positioned to cut hair when the razor blade is used in the shaving system. The blade further includes a peripheral surface extending outwardly from the periphery of said blade planar surface for mounting said blade into a shaving system. Importantly, the apertures are positioned relative to each other so that there is no distance, or a distance of less than 80 microns, between the effective cutting zone of each aperture and the effective cutting zone of each other aperture that is in an adjacent row and adjacent column. Due to this relative positioning, missed hairs are minimized or eliminated entirely. In some embodiments, there is no distance between the effective cutting zones or the effective cutting zones overlap.

In another aspect, the invention features a shaving system including: (a) a cartridge carrying a blade, the blade comprising a metallic foil sheet having a substantially planar surface with a plurality of apertures formed therein, the perimeter of each said aperture forming a cutting edge; and (b) a handle having a distal end on which the cartridge is mounted; wherein a vertical axis of the cartridge is disposed at an angle with respect to a long axis of the handle. In some embodiments, the angle is selected so that when the razor is used with a normal stroking motion there is no distance, or a distance of less than 80 microns, between the effective cutting zone of each aperture and the effective cutting zone of each other aperture that is in an adjacent row and adjacent column.

The invention also features methods of optimizing the shaving performance of a razor that includes a blade comprising a metallic foil sheet having a substantially planar surface with a plurality of apertures formed therein, the perimeter of each said aperture forming a cutting edge. In some cases, the apertures are arranged in an array having rows and columns, and the method includes arranging the apertures so that there is no distance, or a distance of less than 80 microns, between the effective cutting zone of each aperture and the effective cutting zone of each other aperture that is in an adjacent row and adjacent column. For example, the array may be positioned so that, when the blade is mounted in a cartridge, the array will be disposed at an angle with respect to a vertical axis of the cartridge. Other methods include utilizing the razor with a scrubbing motion.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagrammatic front plan view of an upper portion of a razor according to the prior art.

FIG. 2 is a diagrammatic view of the blade of the razor shown in FIG. 1, with effective shaving zone data from the razor of FIG. 1 and the shaving direction employed with this razor superimposed on the blade. FIG. 2A is a highly enlarged illustration of the effective shaving zone data.

FIG. 3 is a diagrammatic view of a blade according to one embodiment of the invention, with effective shaving zone data and shaving direction superimposed on the blade. FIG. 3A is a highly enlarged illustration of the effective shaving zone data.

FIG. 4 is a diagrammatic front plan view of an upper portion of a razor according to another embodiment of the invention. FIG. 4A is a diagrammatic rear plan view of the razor of FIG. 4.

FIG. 5 is a diagrammatic view of the blade of the razor shown in FIG. 4, with effective shaving zone data from the razor of FIG. 4 and the resulting shaving direction of the blade when employed with this razor superimposed on the blade. FIG. 5A is a highly enlarged illustration of the effective shaving zone data.

FIG. 6 is a diagrammatic front plan view of an upper portion of a razor according to another embodiment of the invention. FIG. 6A is a diagrammatic rear plan view of the razor of FIG. 6.

FIGS. 7-7B are diagrammatic views showing the effective shaving zone data when the razor blade shown in FIG. 2 is used with various scrubbing motions.

### DETAILED DESCRIPTION

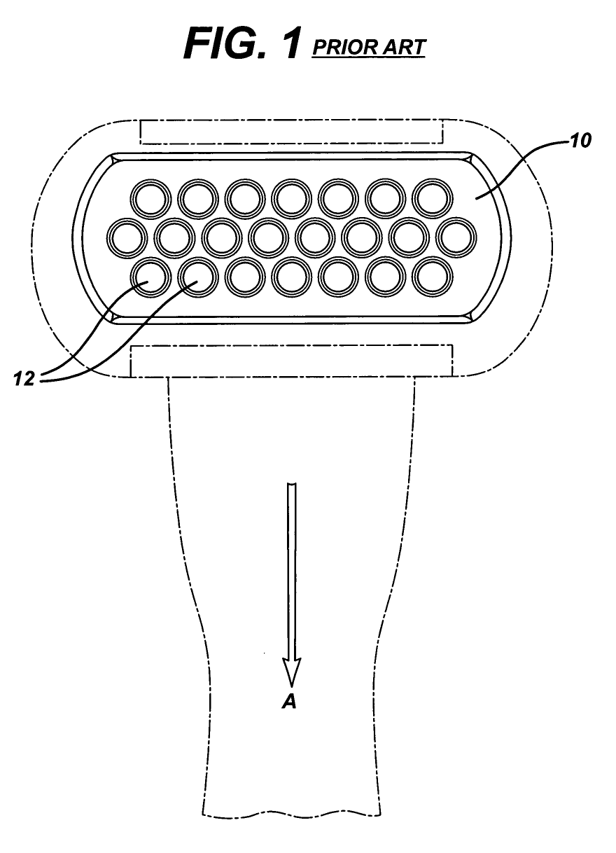

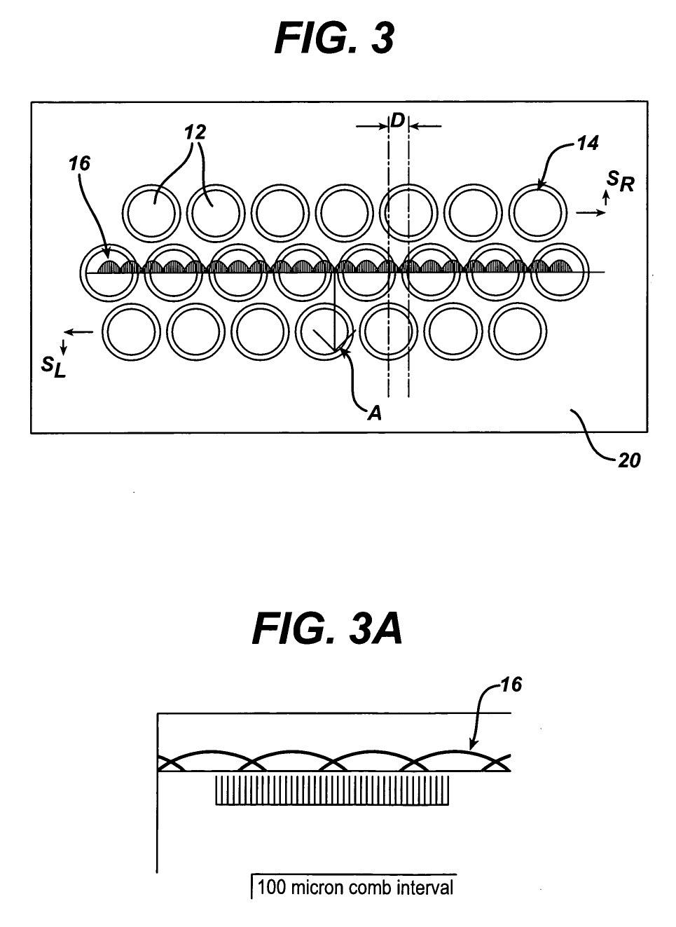

A blade 20, in which the gaps 18 (discussed above) are minimized or eliminated, is shown in FIG. 3. Blade 20 can be used in a razor such as that shown in FIG. 1, in which case blade 20 would generally be oriented in the cartridge in the same manner, and used in the same shaving direction, i.e., direction A indicated in FIG. 3. Blade 20 includes an array of apertures in which the apertures are arranged differently than the apertures in the array on blade 10. As indicated by arrows S_{L} and S_{R}, the top and bottom rows of the array have been shifted right and left, respectively, so that the apertures in these two rows are offset (are not aligned) in the vertical direction. In other words, the center of each aperture is spaced horizontally from the center of each other aperture that is in an adjacent column and spaced two rows away. As shown in FIG. 3, the centers of apertures in adjacent columns in the top and bottom rows are offset horizontally from each other by a distance D. Distance D will vary depending on the configuration of the blade (e.g., the diameter of the apertures and/or the spacing between the apertures within the same row). In some implementations, distance D is between about 0.05 mm and 2 mm, e.g., from about 0.1 to 1 mm. For a blade design in which the apertures have a diameter of 3 mm and a distance, center-to-center, of 4.2 mm, distance D may be between about 0.2 mm and 0.9 mm. By arranging the apertures in this manner, gaps 18 are eliminated and the effective shaving zones actually overlap, as shown diagrammatically in FIG. 3A.

Alternatively, the gaps 18 can be minimized or eliminated by changing the orientation of the array of apertures as a whole relative to the long axis of the handle. Changing the orientation of the entire array will slightly change the radial orientation of the portion of each aperture that constitutes the effective shaving zone. This change of orientation will change the arrangement of the effective shaving zones in a manner similar to that discussed above with reference to FIGS. 3-3A.

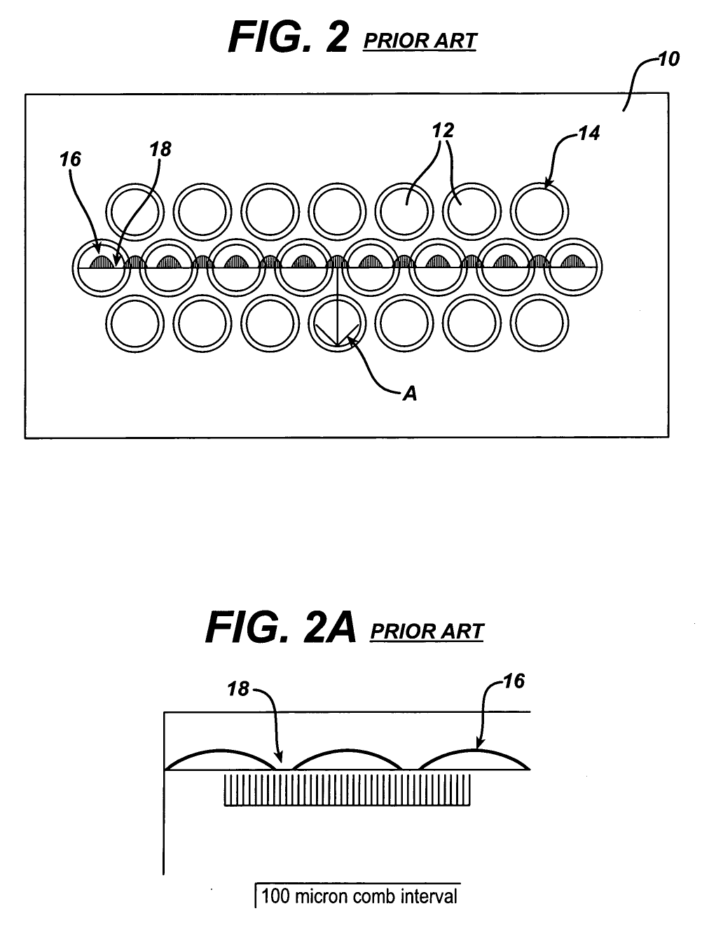

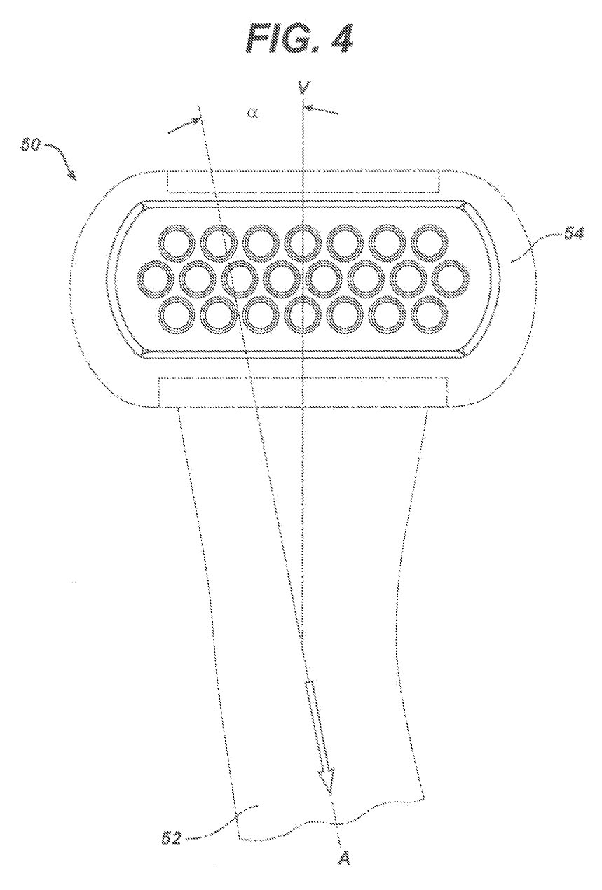

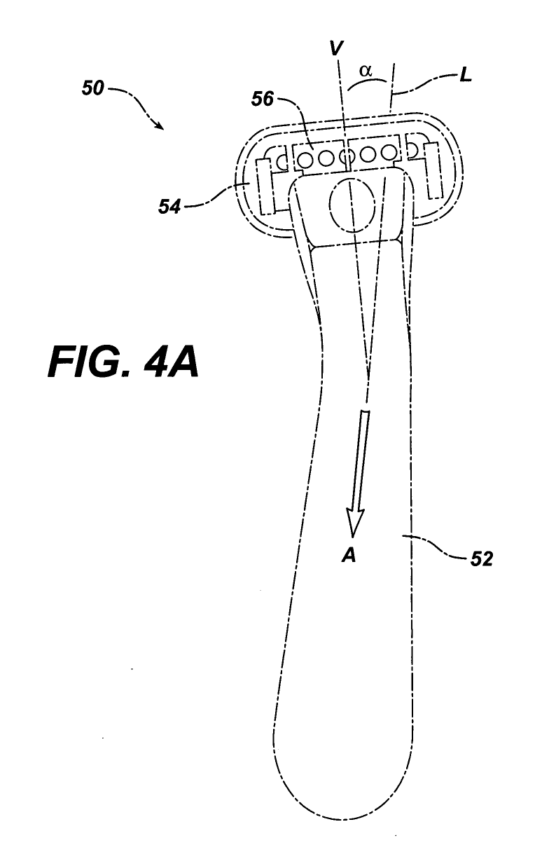

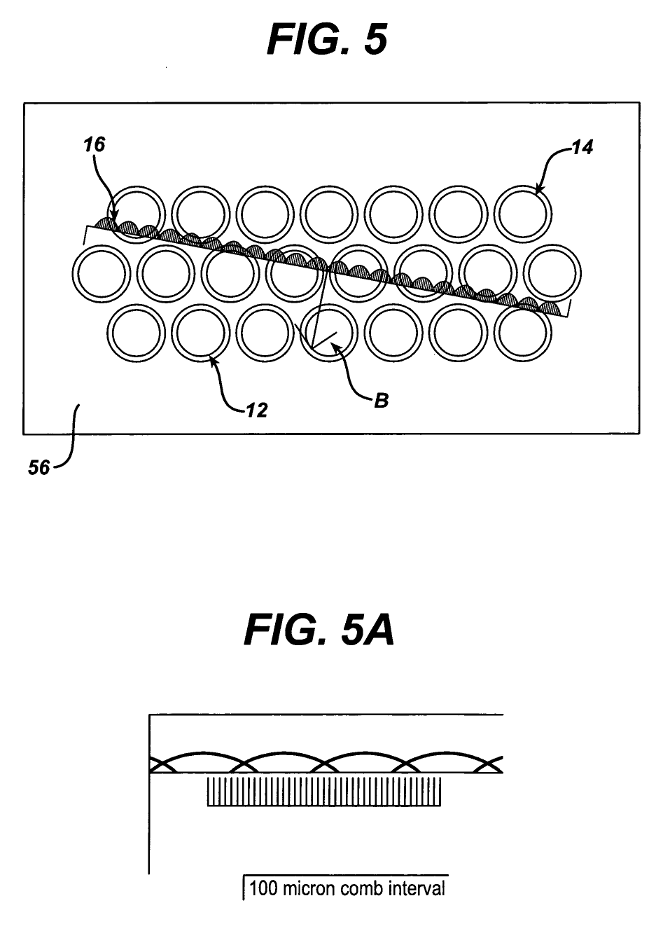

Thus, referring to FIGS. 4-5A, in one embodiment the orientation of the array relative to the long axis L of the handle is changed by changing the orientation of the cartridge relative to the handle. Razor 50 includes a handle 52 and a cartridge 54 mounted on the handle and carrying a blade 56. Blade 56 has substantially the same configuration as the blade 10 discussed above and shown in FIG. 2. The razor differs, however, from the razor shown in FIG. 1 in that the cartridge 54 is mounted so that its vertical axis V is at an angle α relative to the long axis L of the handle. The angle α is selected to provide a desired resulting shaving direction of the blade (arrow B, FIG. 5) that will minimize or eliminate the gaps 18 discussed above, while allowing the user to use a normal shaving stroke (moving the handle in direction A, FIG. 4A). While this angle will vary depending on the configuration of the blade (e.g., the diameter of the apertures and/or the spacing between the apertures within the same row), in some implementations angle α is between about 1 and 25 degrees, e.g., about 2 to 20 degrees. For a blade design in which the apertures have a diameter of 3 mm and a distance, center-to-center, of 4.2 mm, angle α may be from about 2.7 to 15 degrees. The resulting shaving direction B is rotated from the direction in which the user moves the handle (direction A) the same number of degrees.

The cartridge may be mounted at an angle, as discussed above, by providing an angled connector between the cartridge and the handle. Such connectors are well known in the art, and are described, for example, in U.S. Pat. No. 5,956,851, the disclosure of which is incorporated herein by reference. Generally, the cartridge discussed above (often referred to as a blade unit) and the connector are sold together, as an integrated disposable unit (generally referred to as a whole as a “replaceable cartridge”). If desired, in addition to cartridges that are optimized for right-handed users, cartridges may be provided with the connector angled for left-handed users. If desired, the connector may include a pivotable portion, and may be position-settable between a right-handed position and a left-handed position. In this case, the connector is configured to lock in place at the desired “left-handed” angle and “right-handed” angle.

As shown in FIG. 5, when the blade is moved over the skin in the direction indicated by arrow B, gaps 18 are eliminated, and, as shown in detail in FIG SA, the effective shaving zones overlap. If it is not necessary that the effective shaving zones overlap, e.g., if it is acceptable that the “missed hair” phenomenon discussed above be reduced but not entirely eliminated, the angle α may be less. For example, suitable angles in this situation may be from about 0.1 to 10 degrees.

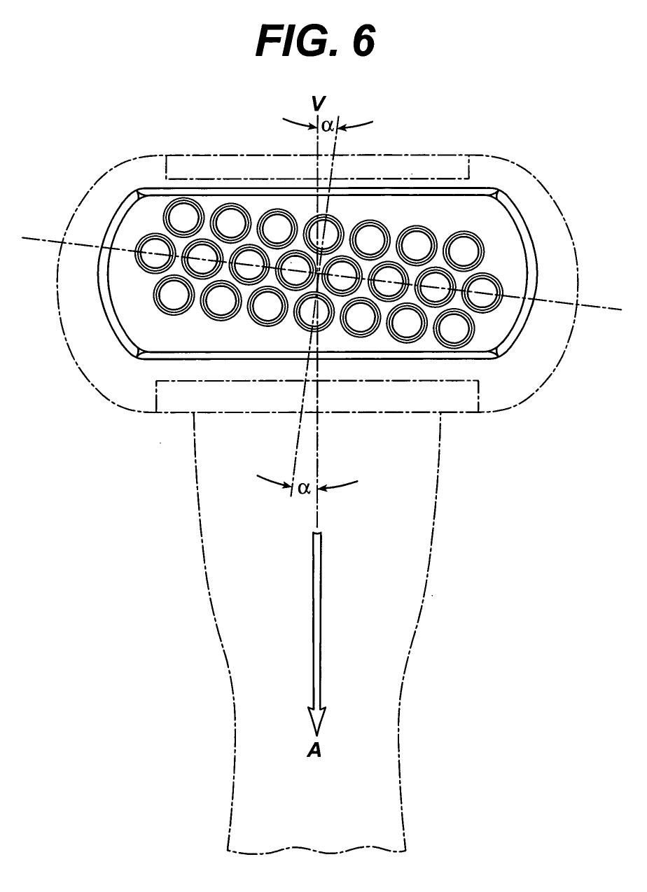

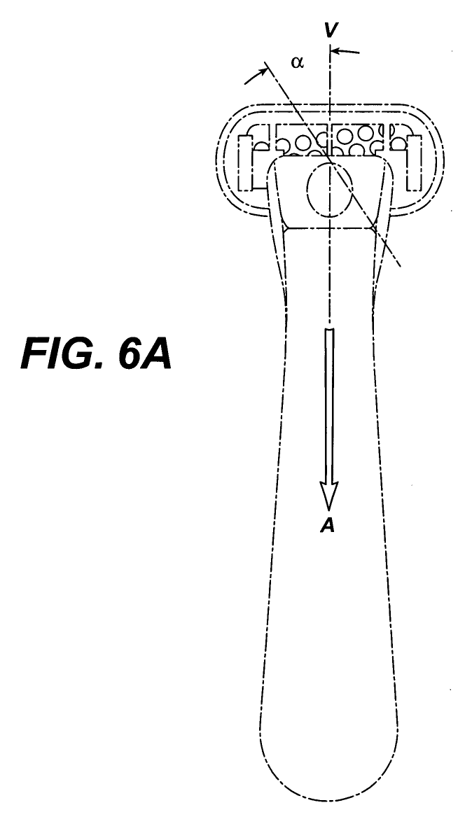

In another embodiment, shown in FIGS. 6-6A, instead of orienting the cartridge at an angle, the array of apertures is oriented at an angle on the blade. Generally, the angle at which the array of apertures is oriented corresponds to the cartridge angles discussed above for the same design conditions. Thus, the array as a whole (and thus any single row in the array) is oriented at an angle with respect to the vertical axis V of the cartridge. This orientation will produce the same results discussed above and illustrated in FIG. 5A.

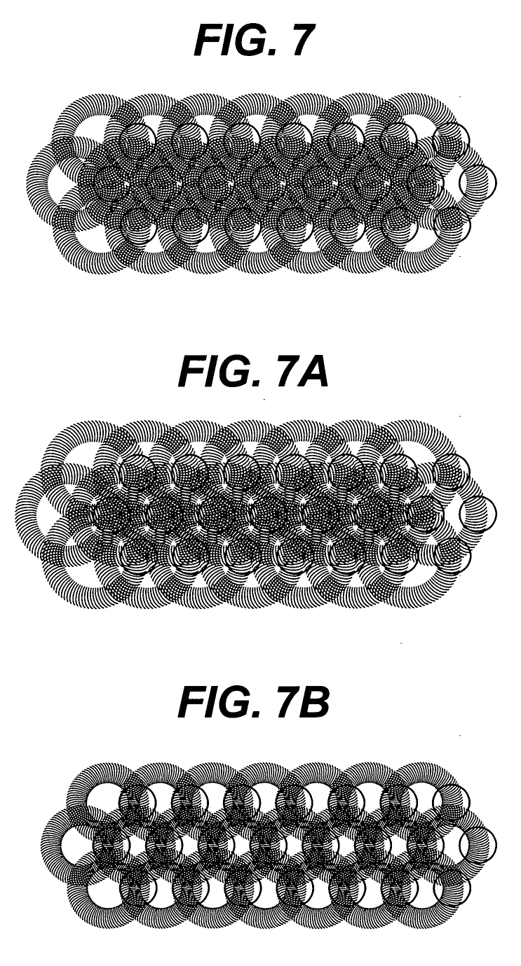

In a further embodiment, shown diagrammatically in FIGS. 7-7B, the gaps 18 are eliminated by altering the shaving direction to include a circular scrubbing motion. It is generally preferred that the scrubbing motion be powered, e.g., using a battery powered razor having a head configured to move in an arcuate path, e.g., circular, oval, or other scrubbing motion. The parameters of the movement may be controlled, for example movement may be circular, having a predetermined diameter. The user is then free to control the direction of the shaving stroke as desired, using linear strokes or other shaving motion that the user is accustomed to.

As indicated in FIGS. 7-7B, the diameter of the circles defined by a circular scrubbing motion will determine whether gaps 18 are reduced or eliminated entirely. For example, in the testing that is illustrated in FIGS. 7-7B, for a blade having apertures 3 mm in diameter, with their centers spaced 4.2 mm apart, a circular motion having a diameter of 6 mm completely eliminated gaps 18 (FIG. 7), while circular motions having diameters of 7 mm (FIG. 7A) and 5 mm (FIG. 7B) reduced but did not eliminate gaps 18. While the optimal diameter of the circular motion will vary depending on the blade design, for many embodiments it is preferred that the diameter of the circular motion be from about 4 mm to 10 mm, e.g., from about 5 mm to 7 mm.

Other embodiments are within the scope of the following claims.

1. A razor blade for employment in a shaving system, said blade comprising:
a metallic foil sheet, said sheet having a substantially planar surface with a plurality of apertures formed therein, the perimeter of each said aperture forming a cutting edge, each cutting edge defining an effective cutting zone that will be positioned to cut hair when the razor blade is used in the shaving system,
said blade further comprising a peripheral surface extending outwardly from the periphery of said blade planar surface for mounting said blade into a shaving system,
wherein the apertures are positioned relative to each other so that there is no distance, or a distance of less than 80 microns, between the effective cutting zone of each aperture and the effective cutting zone of each other aperture that is in an adjacent row and adjacent column.

2. The razor blade of claim 1 wherein there is a distance of from about 0.1 to 1.0 mm between the center of each aperture and the center of each other aperture that is in an adjacent column and spaced two rows away.

3. The razor blade of claim 1 wherein there is no distance between the effective cutting zones.

4. The razor blade of claim 3 wherein the effective cutting zones overlap.

5. The razor blade of claim 1 wherein the array is positioned so that, when the blade is mounted in a cartridge, the array will be disposed at an angle with respect to a vertical axis of the cartridge.

6. The razor blade of claim 5 wherein the angle is from about 1 to 25 degrees.

7. A shaving system comprising:
a cartridge carrying a blade, the blade comprising a metallic foil sheet having a substantially planar surface with a plurality of apertures formed therein, the perimeter of each said aperture forming a cutting edge; and
a handle having a distal end on which the cartridge is mounted;
wherein a vertical axis of the cartridge is disposed at an angle with respect to a long axis of the handle.

8. The shaving system of claim 7 wherein the angle is from about 1 to 25 degrees.

9. The shaving system of claim 7 wherein the angle is selected so that when the razor is used with a normal stroking motion there is no distance, or a distance of less than 80 microns, between the effective cutting zone of each aperture and the effective cutting zone of each other aperture that is in an adjacent row and adjacent column.

10. A method of optimizing the shaving performance of a razor, the razor having a blade comprising a metallic foil sheet having a substantially planar surface with a plurality of apertures formed therein, the perimeter of each said aperture forming a cutting edge and the apertures being arranged in an array having rows and columns, the method comprising:
arranging the apertures so that there is no distance, or a distance of less than 80 microns, between the effective cutting zone of each aperture and the effective cutting zone of each other aperture that is in an adjacent row and adjacent column.

11. The method of claim 10 comprising arranging the apertures so that there is no distance between the effective cutting zones.

12. The method of claim 11 comprising arranging the apertures so that the effective cutting zones overlap.

13. The method of claim 10 comprising positioning the array so that, when the blade is mounted in a cartridge, the array will be disposed at an angle with respect to a vertical axis of the cartridge.

14. The method of claim 13 wherein the angle is from about 1 to 25 degrees.

15. A method of optimizing the shaving performance of a razor, the razor having a blade comprising a metallic foil sheet having a substantially planar surface with a plurality of apertures formed therein, the apertures having a predetermined diameter, the perimeter of each said aperture forming a cutting edge and the apertures being arranged in an array having rows and columns, the method comprising utilizing the razor with a scrubbing motion having a predetermined diameter, the diameter of the scrubbing motion being greater than the diameter of the apertures.

16. The method of claim 15 further comprising actuating a powered scrubbing feature of the razor.

17. The method of claim 16 wherein the scrubbing feature moves the blade in a circular motion having the predetermined diameter of the scrubbing motion.

18. The method of claim 15 wherein the diameter of the scrubbing motion is from about 4 to 10 mm.

19. The method of claim 18 wherein the diameter of the scrubbing motion is from about 5 to 7 mm.

20. The method of claim 15 wherein the diameter of the scrubbing motion is about twice the diameter of the apertures.
